(19) United States
(12) Patent Application Publication
(10) Pub. No.: US 2013/0127284 A1
(43) Pub. Date: May 23, 2013

(54) AIRCRAFT

(71) Applicants: Jens Hamann, Furth (DE); Wolfgang Wolter, Hebershausen (DE)

(72) Inventors: Jens Hamann, Furth (DE); Wolfgang Wolter, Hebershausen (DE)

(73) Assignee: Siemens Aktiengeselschaft, Munchen (DE)

(21) Appl. No.: 13/813,087

(22) PCT Filed: Jul. 26, 2011
(86) PCT No.: PCT/EP11/62777

§ 371 Date: Jan. 29, 2013

(30) Foreign Application Priority Data
Jul. 30, 2010 (EP) 10171438.4

(51) Int. Cl. H02K 21/24; H02K 16/04

(52) U.S. Cl. CPC H02K 21/24; H02K 16/04
USPC 310/156.35; 310/198

(57) ABSTRACT

An aircraft includes a propeller and an electric motor which is constructed in the form of a drive for the propeller. The electric motor includes at least two air gaps that can be used for cooling. The air gaps define an axis of symmetry which corresponds to an axis of rotation of the propeller.

The invention relates to an aircraft having a propeller.

An aircraft which has at least one propeller is for example a fixed-wing aircraft or a rotary-wing aircraft. The storage of electrical energy is becoming increasingly more effective, so that the use of an electric motor as a drive for an aircraft is increasingly gaining in importance. Electrical drive systems are often already used in model aircraft. An aircraft electric motor, as a high-pole motor without gearing (number of magnetic poles=42) with 20 kW at a limit speed of 2500 rpm can be used in model aircraft, which represent small aircraft. In a start phase such an electric motor can perhaps achieve a power to weight ratio of appr. 3.6 kW/kg.

An object of the present invention is to improve the performance of electrically-driven aircraft. This relates not just to model aircraft but for example also to helicopters, transport aircraft, passenger aircraft, drones etc. These are aircraft which can also be equipped with an electric motor as a drive machine.

The object is achieved in particular in accordance with claims 1 to 7.

In an embodiment of an aircraft a permanently-excited motor and a helicopter main propeller can have common bearings. The common bearings can for example have the effect of reducing weight compared to an individual bearing for each of the respective units. The size of the motor is defined by the torque. To have a high torque yield the motor is designed as a high-pole motor, in which the poles lie over a large diameter. In order to increase utilization the motor is disposed in a duplex arrangement. An outer stator and an inner stator can be cooled by means of oil for example.

The armature of the electric motor can have a domed shape for example. High-temperature-resistant permanent magnets are located on the armature. The permanent magnets can be layered for example. This enables the objective of generating as few eddy current losses as possible to be pursued.

The air gap of the electric motor and/or the permanent magnets can be cooled with air. If the stator, i.e. especially the two stator systems, has oil cooling this is to be sealed off from the permanently-excited armature system.

In an embodiment of the aircraft this has a magnetic bearing. This enables the efficiency of the electric drive to be increased. The magnetic bearing or bearings are designed in one version as a regulated magnetic bearing.

An electrical helicopter main propeller is for example able to be embodied such that the drive system has an output of approximately 723 kW @ 365 rpm. The nominal point lies at 75% of the output (542 kW) @ 365 rpm and is to be optimized in respect of efficiency and power to weight ratio. The nominal torque corresponds to 14.1 kNm.

In an embodiment of an aircraft said aircraft is designed such that it produces a specific power to weight ratio of 8 kW/kg. Different measures can contribute to this, which are listed below by way of example, wherein the individual measures or measures able to be combined in any given variation are:
Externally and internally disposed stator (polyphase permanently-excited synchronous machine in a duplex arrangement);
Oil cooling of one or two stators internally and externally with sealing from the air gap;
Rotor embodied as a dome comprising high-impact carbon/Kevlar, wherein high-temperature-resistant permanent magnets are embedded into the rotor;
The rotor dome is attached to the main propeller shaft and is supported by the propeller bearings;
Alternatively main and support bearings as regulated magnetic bearings in order to improve the efficiency and regulate out disruptive torque on the bearing and minimize noise;
The rotor runs in air and is air-cooled; the eddy current losses of the permanent magnets and the radiation losses of the inner surfaces of the outer stator and the outer surface of the internal stator are to be removed by an externally provided air supply;
The rotor has spray oil cooling;
Fewer components through common support of rotor and propeller shaft;
By omitting the gearing a saving in weight is able to be achieved (e.g. appr. 200 kg);
Compact construction and thereby fewer losses and/or lower space requirement;
Embodiment of the winding system of the stator with MICALASTIC T (heat class 200 degrees Celsius);
   low-loss sandwich plates are used for the stator plates; and
Flat litz wire winding (counteracts a high skin effect).

A design of a permanently-excited motor with a peak power of 723 kW @ 365 rpm for a helicopter could be roughly presented as follows:
Air gap diameter approximately 1.1 m;
Pole separation 50 mm;
Appr. 35 pole pairs;
Stator height appr. 150 mm;
Stator width—ring width appr. 120 mm;
Air gap appr. 6 mm; and
Electrical basic frequency appr. 365/60×35=213 Hz

The weight for inner stator+external stator+permanent magnets, based on the above data, can come to appr. 100 kg. This produces a power to weight ratio of 723 kW/100 kg=7.23 kW/kg

In a general and more basic way of looking at the specific embodiments described above an aircraft can consequently have a propeller and an electric motor to drive the propeller, wherein the electric motor has at least two air gaps. Aircraft are also able to be embodied such that these aircraft have a plurality of propellers. With a helicopter these are for example the main rotor and the tail rotor. A propeller in such cases can have one or a plurality of blades.

In an embodiment of the aircraft the electric motor comprises curved linear motor segments.

Various advantages can be linked to segmentation of the electric motor. The purpose of the segmentation can be to make possible a redundancy. This is successful for example during operation at a number of converters so that, on failure of one or more segments, the motor can still be operated with reduced power.

A rotor of the electrical motor is able to be embodied such that said rotor has permanent magnets. The permanent magnets are typically arranged in the shape of a disk or in the shape of a ring.

In a further embodiment of the aircraft the armature of the electric motor, i.e. the rotor of the electric motor, is mechanically connected to a shaft of the propeller, wherein a connecting element comprises a fiber-reinforced plastic.

In a further embodiment of the aircraft the shaft is supported by means of a first bearing and a second bearing, wherein the armature is also supported via the first and second bearing.

In a further embodiment of the aircraft an axis of symmetry corresponds to the air gap of the axis of rotation of the propeller.

The invention is described below with reference to figures, in which:

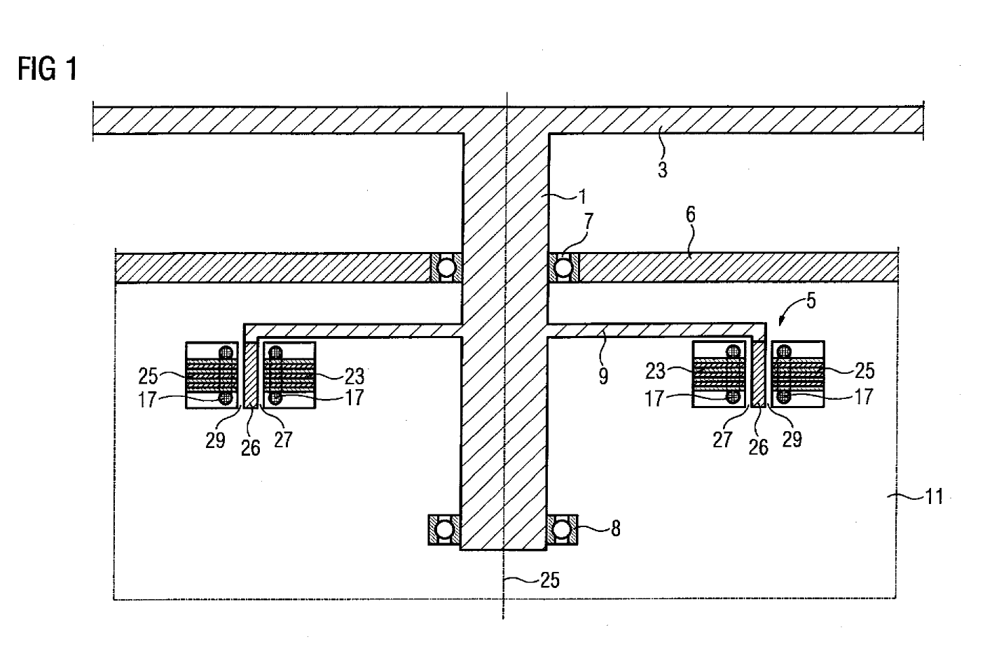

FIG. 1 shows a part section of a helicopter;

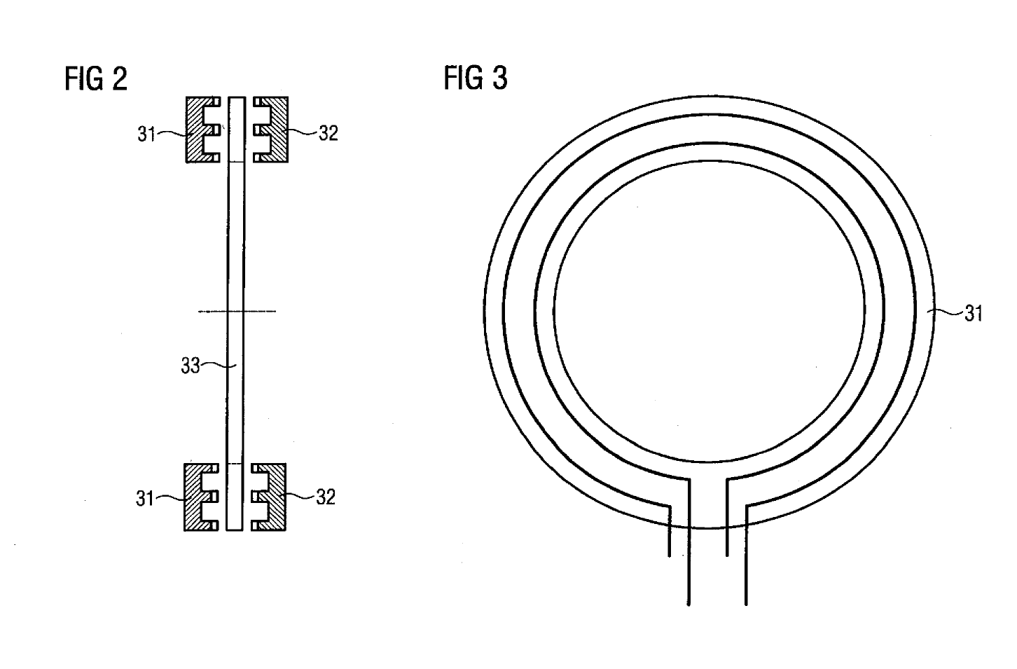

FIG. 2 shows a stator ring and a rotor;

FIG. 3 shows an overhead view of a stator; and

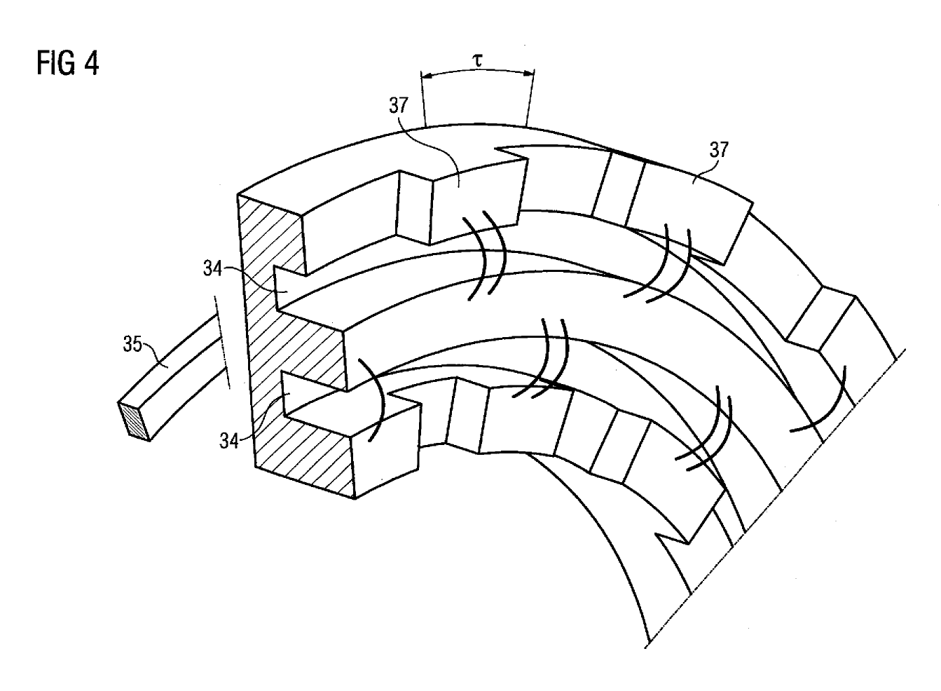

FIG. 4 shows a perspective view of a stator.

The diagram depicted in FIG. 1 shows a propeller 3, which is coupled via a shaft 1 to an electric motor 5 driving the propeller 3. The electric motor 5 has a first stator 23 and a second stator 25, wherein the first stator 23 and the second stator 25 are embodied in the shape of a circle or in the shape of a ring respectively. The first stator 23 can be designated as an inner stator, wherein the second stator can be designated as an outer stator. There are air gaps 27 and 29 between the stators 23 and 25. The stators 23 and 25 have windings and thus also winding heads 17.

The rotor 9 is constructed in a dome shape and has permanent magnets 26 in its end area. The rotor 9 has a mechanical connection to the shaft 1, wherein said shaft is supported towards a helicopter housing (roof) 6 by means of a main bearing 7 for propeller and motor. Furthermore the shaft 1 is supported via a support bearing 8. The shaft 1 has an axis of rotation 25, wherein this axis coincides with the axis of symmetry and/or axis of rotation of the rotor 9.

Attached to the roof 6 of the helicopter is a housing 11 of the electric motor 5.

The inner stator ring 23 and/or the outer stator ring 25 can be cooled by means of oil. The permanent magnets 26 of the rotor 9 can be layered and embedded in a carbon dome and/or Kevlar dome. In this case an oil-cooled double-stator motor with common propeller bearings, as well as having a good cooling characteristic, also has a good power to weight ratio, since motor and propeller have common bearings.

The diagram in accordance with FIG. 2 shows a schematic of a layout for a simple stator ring 31 and 32, wherein a carbon fiber reinforced rotor disk 33 is provided. By contrast with FIG. 1, in FIG. 2 the rotor is no longer dome-shaped but disk-shaped.

The diagram depicted in FIG. 3 shows a stator ring 31 according to FIG. 2 from another perspective. An electric motor constructed in this way makes use of the transverse flux principle. This means that in an embodiment of the aircraft, said aircraft has a transverse flux motor as a drive for a propeller. This can be constructed as a two-phase or three-phase motor.

The diagram depicted in FIG. 4 shows sections of a perspective diagram of a stator of a transverse flux machine, with teeth 37 and winding slots 34 for windings 35 of the stator. The windings in this motor but also in other motor types can feature a metal composite material for example. Ring windings can further be embodied such that said windings are hollow internally and in this way for example can be cooled internally by water. Copper/aluminum alloys can be used for such windings.

What is claimed is:

1.-7. (canceled)

8. An aircraft, comprising:
a propeller; and
an electric motor configured to drive the propeller, said electric motor having two stators separated by a rotor to define at least two air gaps there between.

9. The aircraft of claim 8, wherein the electric motor is a polyphase permanently-excited synchronous machine.

10. The aircraft of claim 8, wherein the electric motor has curved linear motor segments.

11. The aircraft of claim 8, wherein the rotor has a dome-shaped configuration and defines end areas provided with permanent magnets.

12. The aircraft of claim 8, wherein the rotor is configured for mechanical connection to a shaft of the propeller, said rotor containing fiber-reinforced plastic.

13. The aircraft of claim 12, wherein the rotor is configured in the form of a disk made of carbon-fiber reinforced plastic.

14. The aircraft of claim 12, further comprising first and second bearings for support of the shaft, said rotor being supported via the first and second bearings.

15. The aircraft of claim 8, wherein the air gaps define an axis of symmetry which corresponds to an axis of rotation of the propeller.

16. The aircraft of claim 8, further comprising a magnetic bearing supporting at least one of the propeller and the electric motor.

17. The aircraft of claim 8, wherein the stators are arranged in duplex arrangement to define an inner stator and an outer stator.
